(19) United States
(12) Patent Application Publication
(10) Pub. No.: US 2013/0203007 A1
(43) Pub. Date: Aug. 8, 2013

(54) APPARATUS AND METHODS FOR GAS TIGHT SECONDARY COPPER STAVE SUPPORT

(71) Applicants: Todd G. Smith, Harmony, PA (US); Allan MacRae, Hayward, CA (US)

(72) Inventors: Todd G. Smith, Harmony, PA (US); Allan MacRae, Hayward, CA (US)

(73) Assignee: Berry Metal Company, Harmony, PA (US)

(21) Appl. No.: 13/147,996

(22) PCT Filed: Mar. 30, 2011
(86) PCT No.: PCT/US11/30591

§ 371 Date: Dec. 23, 2011

Related U.S. Application Data
(60) Provisional application No. 61/318,977, filed on Mar. 30, 2010.

(51) Int. Cl. F27D 9/00; B23P 19/00

(52) U.S. Cl. CPC F27D 9/00; B23P 19/00
USPC 432/238; 228/101; 164/47; 29/525.01

(57) ABSTRACT

A secondary stave support for a furnace stave with a water pipe having a first portion of the water pipe external to the furnace stave and a second portion of the water pipe also external to a furnace shell wall comprising: a protection pipe having first and second ends, wherein the protection pipe is coaxially disposed about the water pipe with the first end nearest the stave; and a first gas-tight seal, disposed between the first end of the protection pipe and a third portion of the water pipe, prevents gas flow from within the furnace shell wall into an annular space between the protection pipe and the water pipe.

### CROSS-REFERENCE TO RELATED APPLICATIONS

The present application claims benefit and priority from U.S. provisional application Ser. No. 61/318,977 entitled “Apparatus And Method For Gas Tight Secondary Copper Stave Support,” filed on Mar. 30, 2010, the disclosure of which is hereby incorporated by reference herein in its entirety for all purposes.

### FIELD OF THE INVENTION

This invention relates to apparatus and methods for cooling the furnace shell of blast furnaces and other metallurgical furnaces.

### BACKGROUND OF THE INVENTION

Cast iron staves have been used for many years with a cast-in protection pipe around each water feed and discharge pipe. This pipe was rigidly fastened to the furnace shell by various methods to act as a secondary support to the bolts which hold the stave. These cast-in protection pipes were often welded via a closure ring to the water pipe outside the shell to prevent furnace gas from escaping. This was required because the cast in pipe may not form a sufficient bond to the casting material to prevent gas from entering the area between the protection pipe and the water pipe. Also, after years of service the cast iron staves typically crack and would allow gas to enter this area.

Copper staves were developed years after the cast iron staves. These staves were originally developed as a drilled and plugged design where a copper billet is drilled, and water pipes are welded on the back for the feeds and discharges. Numerous failures have occurred over the past two decades at this weld connection. These staves were made with welded protection pipes that did not protrude through the shell. Typical designs allow the welded protection pipe to float inside the furnace by surrounding it with a crushable material and pouring a castable material around it. The water pipes protrude through the shell and are attached by means of a flexible compensator. This offers no secondary support for the stave. Therefore, at least one support pin is added to the copper stave to act as the secondary support mechanism. These flexible compensators have been known to fail on a frequent basis. There have been numerous cases of furnace gas leakage through compensators directly after installation.

The secondary stave support of the present invention may be incorporated into cast iron, cast copper or drilled and plugged staves. It would be desirable to utilize the protection pipe as the furnace gas seal and secondary support for the stave, and the water pipe as the water seal thereby leaving the water pipe free to move within the protection pipe.

These and other advantages of the invention will be appreciated by reference to the detailed description of the preferred embodiment(s) that follow.

### BRIEF SUMMARY OF THE INVENTION

In a first aspect, the present invention comprises a secondary stave support for a furnace stave with a water pipe having a first portion of the water pipe external to the furnace stave and a second portion of the water pipe also external to a furnace shell wall comprising: a protection pipe having first and second ends, wherein the protection pipe is coaxially disposed about the water pipe with the first end nearest the stave; and a first gas-tight seal, disposed between the first end of the protection pipe and a third portion of the water pipe, preventing gas flow from within the furnace shell wall into an annular space between the protection pipe and the water pipe.

In accordance with another aspect of the secondary stave support, the second portion of the water pipe external to the furnace shell wall is not connected directly, or indirectly by any means or structure, to the protection pipe.

In yet another aspect of the secondary stave support, neither the first or second portions of the water pipe are connected directly, or indirectly by any means or structure, to the protection pipe.

In a further aspect of the secondary stave support, the annular space between the protection pipe and the water pipe is empty space and the second end of the protection pipe is open.

In yet another aspect of the secondary stave support, the first end of the protection pipe is flared outwards and cast within the stave along with the third portion of the water pipe.

In an additional aspect of the secondary stave support, the first gas-tight seal is disposed within the stave.

In a further aspect of the secondary stave support, the first gas-tight seal is formed as part of the stave.

In another aspect of the secondary stave support, the first gas-tight seal is external to the stave.

In yet an additional aspect of the secondary stave support, the first gas-tight seal comprises a connection, between the first end of the protection pipe and the third portion of the water pipe, selected from the group consisting of soldering, brazing, threading, or welding.

In a further aspect, the secondary stave support further comprises a second gas-tight seal between the protection pipe and an external part of the stave, wherein the second gas-tight seal is disposed on the protection pipe between the first and second ends of the protection pipe.

In another aspect of the secondary stave support, the second gas-tight seal comprises a connection selected from the group consisting of soldering, brazing, threading, or welding. In an additional aspect of the secondary stave support, the protection pipe is connected directly to the furnace shell wall.

In a further aspect, the secondary stave support further comprises a closure plate connected to the furnace shell wall and wherein the protection pipe extends through an opening in the closure plate and is connected to the closure plate.

In another aspect, the secondary stave support further comprises a rigid compensator connected to the furnace shell wall and wherein the protection pipe extends through an opening in the rigid compensator and is connected to the rigid compensator.

In yet a further aspect of the secondary stave support, the water pipe further comprises a fourth portion and wherein the third and fourth portions of the water pipe are integrally cast with the stave.

In an additional aspect of the secondary stave support, the third portion of the water pipe is disposed within the stave and connected thereto by a connection selected from the group consisting of soldering, brazing, threading, or welding.

In a further aspect of the secondary stave support, the first gas-tight seal comprises a connection, between an inner surface of the first end of the protection pipe and an outside surface of the third portion of the water pipe, selected from the group consisting of soldering, brazing, threading, or welding.

In yet another aspect, the secondary stave support further comprises a second gas-tight seal between an outer surface of the first end of the protection pipe and an external part of the stave.

In another aspect, the secondary stave support further comprises a rigid compensator connected to the furnace shell wall and wherein the second end of the protection pipe extends through an opening in the rigid compensator and is connected to the rigid compensator.

In a further aspect of the secondary stave support, the first gas-tight seal comprises a seal ring connected to the first end of the protection pipe and a third portion of the water pipe.

In an additional aspect of the secondary stave support, the first gas-tight seal, comprising the seal ring connected to the first end of the protection pipe and a third portion of the water pipe, is cast into the stave.

In yet another aspect of the secondary stave support, the seal ring tapers from a large diameter end to a small diameter end. In a further aspect of the secondary stave support, at least a portion of the seal ring is cast within the stave. In another aspect of the secondary stave support, at least the large diameter end of the seal ring is cast within the stave.

In yet an additional aspect of the secondary stave support, the large diameter end of the seal ring is cast within the stave and the small diameter end of the seal ring protrudes from the stave. In a further aspect, the secondary stave support further comprises a second gas-tight seal between an outer surface of the first end of the protection pipe and the small diameter end of the seal ring. In another aspect of the secondary stave support, the first gas-tight seal is external to the stave.

In yet a further aspect, the present invention comprises a method for providing a secondary stave support for a furnace stave with a water pipe having a portion external to the furnace shell wall comprising the steps of: attaching in an gas-tight manner a first end of a protection pipe to an internal co-axial water pipe proximal to the stave; and attaching in an gas-tight manner a second end of the protection pipe to the furnace shell wall such that the second end is not in physical communication with the water pipe portion external to the furnace shell wall.

In a further aspect of the method for providing a secondary stave support for a furnace stave, the manner for attaching the first end is selected from welding, brazing, threading or casting.

In another of the method for providing a secondary stave support for a furnace stave, the manner for attaching the second end is selected from welding, brazing, threading or casting.

### BRIEF DESCRIPTION OF THE SEVERAL VIEWS OF THE DRAWING

For the present disclosure to be easily understood and readily practiced, the present disclosure will now be described for purposes of illustration and not limitation in connection with the following figures, wherein:

FIG. 1 is a side cross-sectional view of a conventional cast stave secondary support comprising a water protection pipe with closure plate support utilizing refractory or grout material in the annular space between the water protection pipe and the water pipe to prevent leakage of carbon monoxide and/or other gases;

FIG. 2 is a side cross-sectional view of a conventional cast stave secondary support comprising a water protection pipe with closure plate support utilizing a seal ring to seal the annular space between the water protection pipe and the water pipe to prevent leakage of carbon monoxide and/or other gases;

FIG. 3 is a side cross-sectional view of a conventional cast stave secondary support comprising a water protection pipe with a rigid compensator and a seal ring to prevent leakage of carbon monoxide and/or other gases;

FIG. 4 is a side cross-sectional view of a conventional cast stave secondary support comprising a water protection pipe with a flexible compensator and a seal ring to prevent leakage of carbon monoxide and/or other gases;

FIG. 5 is a side cross-sectional view of a conventional drilled and plugged stave secondary support comprising a water protection pipe with a flexible compensator sealed to water pipe to prevent leakage of carbon monoxide and/or other gases;

FIG. 6 is a side cross-sectional view of a preferred embodiment of a gas tight secondary stave support of the present invention comprising a water protection pipe having a flared end integrally cast within the stave;

FIG. 7 is a side cross-sectional view of a preferred embodiment of a secondary stave support of the present invention comprising a water protection pipe and employing gas tight mechanical connections between the water pipe and stave and also between the protection pipe and stave;

FIG. 8 is a side cross-sectional view of a preferred embodiment of a secondary stave support of the present invention comprising gas tight mechanical connections between the seal ring and the water pipe and also between the seal ring and the protection pipe wherein such assembly including the seal ring is cast within the stave; and

FIG. 9 is a side cross-sectional view of a preferred embodiment of a secondary stave support of the present invention comprising a water protection pipe and a tapered seal ring cast within the stave and gas tight mechanical connections between the seal ring and the protection pipe, which may also be cast within the stave.

### DETAILED DESCRIPTION OF THE INVENTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

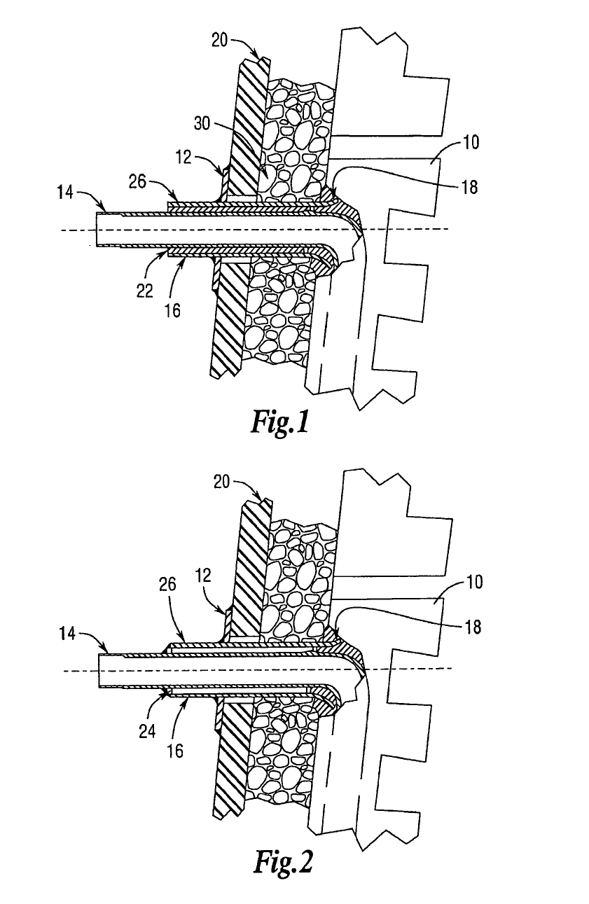

FIG. 1 illustrates a conventional design for a secondary support for a cast stave 10 comprising a protection pipe 16 with closure plate or ring 12. The stave water pipe 14 has a coaxial flared protection pipe 16 with a first end 18 cast into the stave 10. The protection pipe 16 is welded to a closure plate 12, which in turn is welded to the furnace shell wall 20. Between the water pipe 14 and the protection pipe 16, refractory or grout material 22 is installed to prevent leakage of carbon monoxide from within the furnace.

FIG. 2 illustrates another conventional cast stave secondary support comprising a closure plate 12 and a seal ring 24 welded to the second end 26 of the protection pipe 16 and the stave water pipe 14.

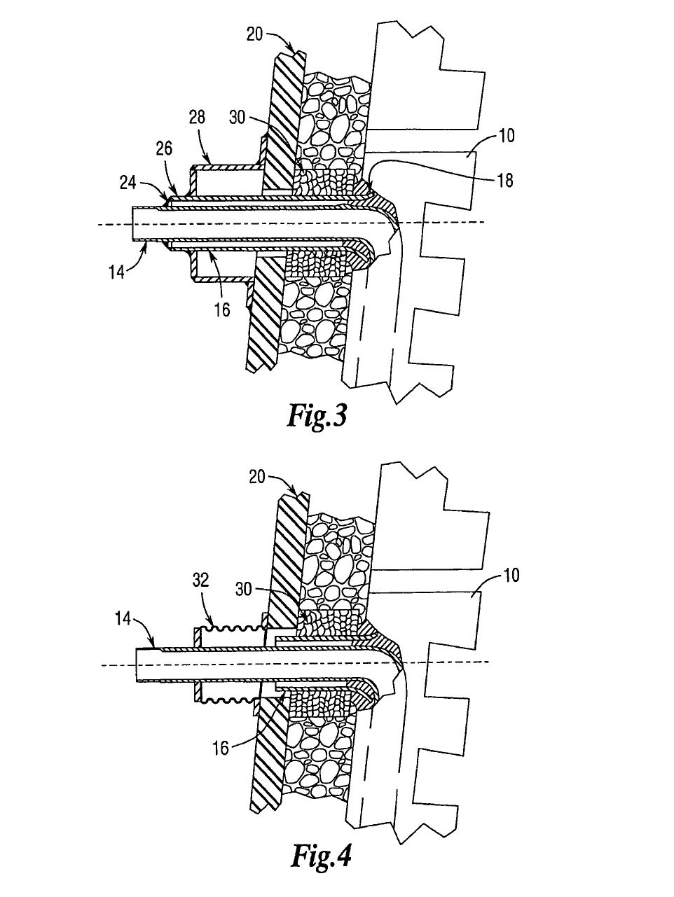

FIG. 3 illustrates a similar conventional design for a cast stave secondary support comprising a rigid compensator 28 instead of a closure plate 12. A seal ring 24 is welded to the second end 26 of the protection pipe 16 and the stave water pipe 14. This conventional design for a cast stave secondary support has been used with or without gasket material 30 adjacent to the protection pipe 16 and between the stave 10 and furnace shell wall 20.

FIG. 4 illustrates yet another conventional design for a cast stave secondary support comprising a flexible compensator 32 attached to the water pipe 14 and also to the furnace shell wall 20. In this conventional design, the protection pipe 16 does not extend beyond the furnace shell wall 20. This conventional design for a cast stave secondary support having a water protection pipe 16 has been used with or without gasket material 30 adjacent to the protection pipe 16 and between the stave 10 and furnace shell wall 20.

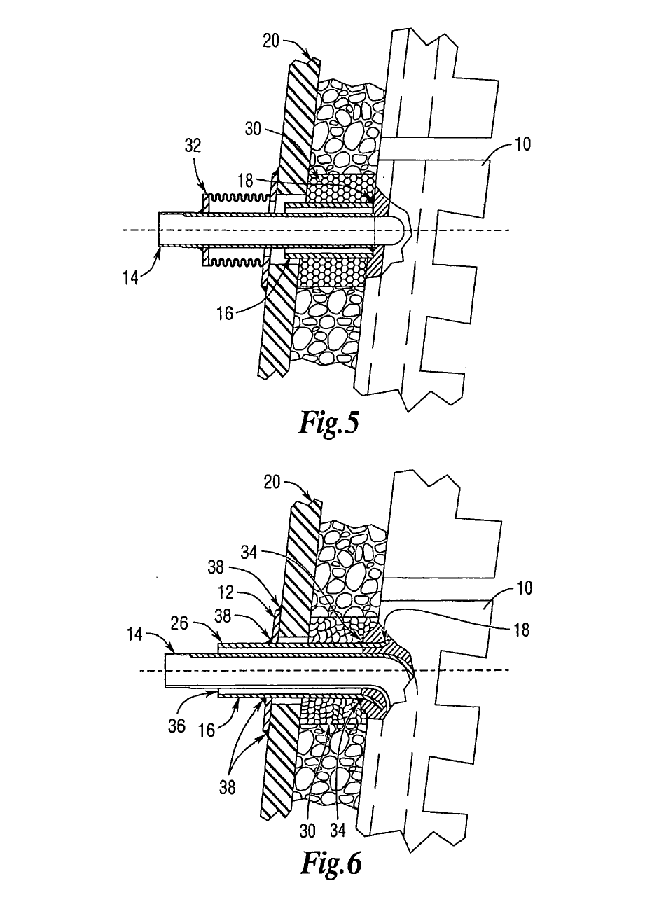

FIG. 5 shows a conventional drilled and plugged stave secondary support having a water protection pipe 16 with a flexible compensator 32 sealed to water pipe 14 and to furnace shell wall 20 to prevent leakage of carbon monoxide and/or other gases from within the furnace. In this conventional design, the protection pipe 16 does not extend beyond the furnace shell wall 20.

In each of the conventional designs the water pipe 14 is attached to either the protection pipe 16, as in FIGS. 1-3, or to the furnace shell wall 20, as in FIGS. 4-5. While FIGS. 3-5 illustrate the presence of gasket materials 30 for expansion, the use of gasket materials 30 and compensators attached to the water pipe 14 in any combination are part of the prior art. An improved design would utilize the protection pipe 16 as the furnace gas seal and for secondary support for the stave 10 leaving the water pipe 14 free to move within the protection pipe 16.

One aspect of the present invention is to utilize the protection pipe 16 as the furnace gas seal and secondary support for the stave 10 and the water pipe 14 as the water seal leaving the water pipe 14 free to move within the protection pipe 16. Thus, each of the preferred embodiments of the stave secondary support of the present invention could be incorporated into cast iron staves, cast copper staves or drilled and plugged staves.

A first preferred embodiment of the stave secondary support of the present invention, as shown in FIG. 6, comprises protection pipe 16 that extends outside of furnace shell 20 having a first end 18 and a second end 26. Preferably, welds or other connections 38 as described herein are made between closure plate 12 and protection pipe 16 and also between closure plate 12 and furnace shell 20. Alternately, the protection pipe 16 may be attached by welding, brazing, soldering, etc., directly to the furnace shell 20. Preferably, the first end 18 of protection pipe 16 is flared and fitted over the water pipe 14 with both the water pipe 14 and the protection pipe 16 being cast into stave 10 as shown in FIG. 6. Thus, a gas-tight seal 34 between the stave 10, the water pipe 14 and the protection pipe 16 is formed to prevent leakage of carbon monoxide and/or other gases from within the furnace into the annular space 36 between the water pipe 14 and the protection pipe 16. In an alternative preferred embodiment the stave secondary support of FIG. 6, the flared protection pipe 16 may be welded to stave 10 instead of being cast into the stave 10. Preferably, protection pipe 16 is made from a material that promotes or augments a gas-tight seal or connection being formed when protection pipe 16 is cast into or welded or otherwise connected to stave 10. The cast stave secondary support of FIG. 6 may be used with or without gasket material 30 adjacent to the protection pipe 16 and between the stave 10 and furnace shell wall 20.

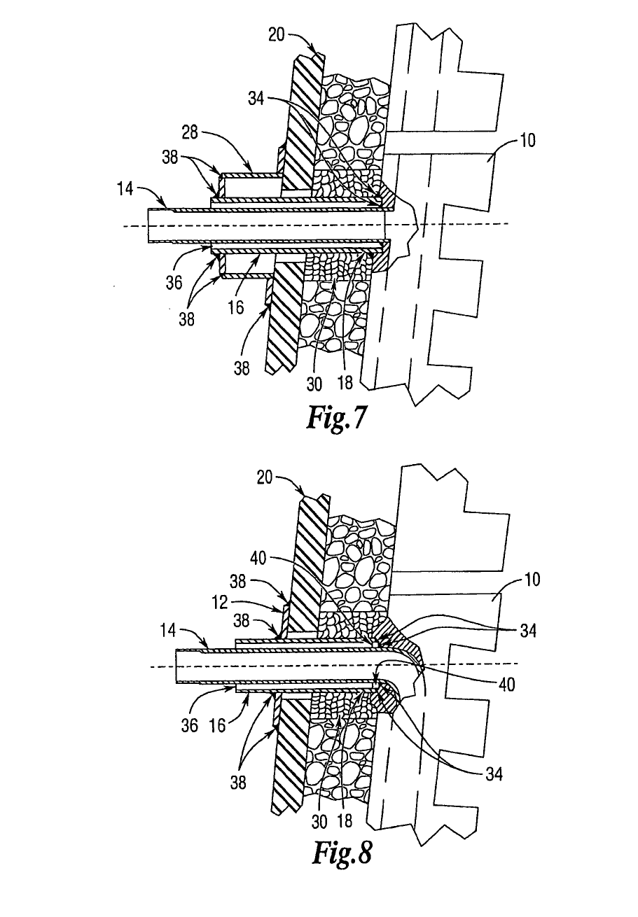

Another preferred embodiment of the stave secondary support of the present invention for a “drilled and plugged” stave 10, as shown in FIG. 7, comprises protection pipe 16 that extends outside of furnace shell 20 and a rigid compensator 28 fastened to protection pipe 16 and furnace shell 20 by gas-tight, connections 38 which may comprise threadings, brazings, solder, welds or any other adequate mechanical connection known in the art. Alternately, the protection pipe 16 may be attached by welding, brazing, soldering, etc., directly to the furnace shell 20 or a closure plate 12 as described above in reference to FIG. 6. Each of the stave water pipe 14 and a first end 18 of protection pipe 16 is fastened to stave 10 by gas-tight, connections 34 which may comprise threadings, brazings, solder, or welds or any other adequate mechanical gas-tight connection known in the art. Preferably, protection pipe 16 is made from a material that promotes or augments a gas-tight seal or connection being formed when protection pipe 16 is cast into or welded or otherwise connected to stave 10. In the preferred construction of the stave secondary support of FIG. 7, the stave 10 and/or gas-tight, connections 34 prevent furnace gas from entering the area 36 between the protection pipe 16 and water pipe 14. The cast stave secondary support of FIG. 7 may be used with or without gasket material 30 adjacent to the protection pipe 16 and between the stave 10 and furnace shell wall 20.

A further preferred embodiment of the stave secondary support of the present invention, as shown in FIG. 8, comprises protection pipe 16 that extends outside of furnace shell 20 and a closure plate 12. Preferably, gas-tight connections 38 which may comprise threadings, brazings, solder, welds or any other adequate mechanical connection known in the art, preferably are made between closure plate 12 and protection pipe 16 and also between closure plate 12 and furnace shell 20. As described above with respect to FIGS. 6 and 7, a rigid compensator 28 may be used instead of closure plate 12 to fasten protection pipe 16 to the furnace shell 20 or the protection pipe 16 may be attached by welding, brazing, soldering, etc., directly to the furnace shell 20. As shown in FIG. 8, the first end 18 of a protection pipe 16 is fitted over a smaller concentric stave water pipe 14. Both first end 18 of a protection pipe 16 and water pipe 14 are fastened to a seal ring 40 using gas-tight connections 34 which may comprise solder, brazing, threadings, welds or other mechanical connection as described herein or known in the art. Preferably, stave 10 is then cast around these connections 34 to incorporate them into the stave 10 to further prevent the possibility for leakage of carbon monoxide and/or other gases from within the furnace into the annular space 36 between the water pipe 14 and the protection pipe 16. Preferably, protection pipe 16 and seal ring 40 are made from a material that promotes or augments a gas-tight seal or connection being formed when protection pipe 16 and/or seal ring 40 are cast into or welded or otherwise connected to stave 10 or each other. The cast stave secondary support of FIG. 8 may be used with or without gasket material 30 adjacent to the protection pipe 16 and between the stave 10 and furnace shell wall 20.

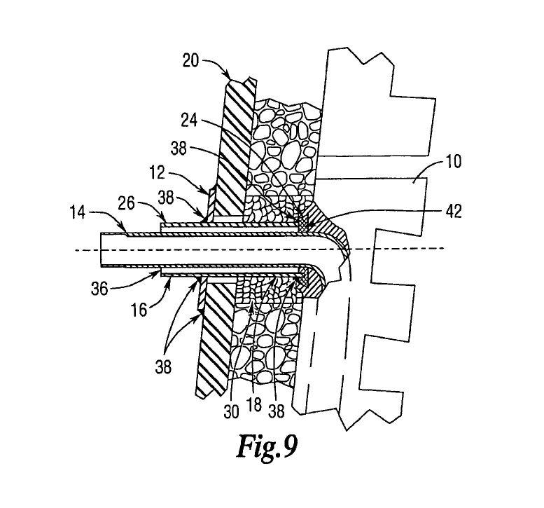

Another preferred embodiment of the stave secondary support of the present invention, as shown in FIG. 9, comprises protection pipe 16 that extends outside of furnace shell 20 and a closure plate 12. Preferably, gas-tight connections 38 which may comprise threadings, brazings, solder, welds or any other adequate mechanical connection described herein or known in the art, preferably are made between closure plate 12 and protection pipe 16 and also between closure plate 12 and furnace shell 20. As described above with respect to FIGS. 6 and 7, a rigid compensator 28 may be used instead of closure plate 12 to fasten protection pipe 16 to the furnace shell 20 or the protection pipe 16 may be attached by welding, brazing, soldering, etc., directly to the furnace shell 20. As shown in FIG. 9, the first end 18 of a protection pipe 16 is fitted over a smaller concentric stave water pipe 14. Preferably, connections 38 are also made between first end 18 of a protection pipe 16 and a small diameter end of tapered seal ring 42 through which water pipe 14 preferably extends. Such assembly comprising of the first end 18 of a protection pipe 16, tapered seal ring 42 and a portion of water pipe 14 preferably are cast into stave 10 to further prevent the possibility for leakage of carbon monoxide and/or other gases from within the furnace into the annular space 36 between the water pipe 14 and the protection pipe 16. This same construction employing tapered seal ring 42 may be used even if not cast into stave 10 whereupon mechanical connections 38 could also be made between water pipe 14 and the seal ring 42 and between stave 10 and the seal ring 42. Preferably, protection pipe 16 and seal ring 42 are made from a material that promotes or augments a gas-tight seal or connection being formed when protection pipe 16 and/or seal ring 42 are cast into or welded or otherwise connected to stave 10 or each other. Again, the cast stave secondary support of FIG. 9 may be used with or without gasket material 30 adjacent to the protection pipe 16 and between the stave 10 and furnace shell wall 20.

The components of the secondary stave support including, without limitation, water pipe 14, protection pipe 16, and seal rings 40 and 42 preferably comprise one or more materials selected to promote gas tight bonding, such as steel or stainless steel. The protection pipe 16 and its attachment to the furnace shell wall 20 are designed to deflect or withstand stave expansion without compromising the attachment method to the stave 10 while maintaining a gas tight seals. Thus, the protection pipe 16 is attached to the shell wall 20 by a method to supply secondary support for the stave 10 and gas tight seals 34 and 38 that may be employed. Further, any other mechanical method could be used to attach the protection pipe 16 to the shell wall 20 that would act as a secondary support for the stave 10 and maintain the integrity of any gas-tight seals 34 and 38 that may be employed.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A secondary stave support for a furnace stave with a water pipe having a first portion of the water pipe external to the furnace stave and a second portion of the water pipe also external to a furnace shell wall comprising:
a protection pipe having first and second ends, wherein the protection pipe is coaxially disposed about the water pipe with the first end nearest the stave; and
a first gas-tight seal, disposed between the first end of the protection pipe and a third portion of the water pipe, preventing gas flow from within the furnace shell wall into an annular space between the protection pipe and the water pipe.

2. The secondary stave support of claim 1 wherein the second portion of the water pipe external to the furnace shell wall is not connected directly, or indirectly by any means or structure, to the protection pipe.

3. The secondary stave support of claim 1 wherein neither the first or second portions of the water pipe are connected directly, or indirectly by any means or structure, to the protection pipe.

4. The secondary stave support of claim 1 wherein the annular space between the protection pipe and the water pipe is empty space and the second end of the protection pipe is open.

5. The secondary stave support of claim 1 wherein the first end of the protection pipe is flared outwards and cast within the stave along with the third portion of the water pipe.

6. The secondary stave support of claim 1 wherein the first gas-tight seal is disposed within the stave.

7. The secondary stave support of claim 1 wherein the first gas-tight seal is formed as part of the stave.

8. The secondary stave support of claim 1 wherein the first gas-tight seal is external to the stave.

9. The secondary stave support of claim 1 wherein the first gas-tight seal comprises a connection, between the first end of the protection pipe and the third portion of the water pipe, selected from the group consisting of soldering, brazing, threading, or welding.

10. The secondary stave support of claim 1 further comprising a second gas-tight seal between the protection pipe and an external part of the stave, wherein the second gas-tight seal is disposed on the protection pipe between the first and second ends of the protection pipe.

11. The secondary stave support of claim 10 wherein the second gas-tight seal comprises a connection selected from the group consisting of soldering, brazing, threading, or welding.

12. The secondary stave support of claim 1 wherein the protection pipe is connected directly to the furnace shell wall.

13. The secondary stave support of claim 1 further comprising a closure plate connected to the furnace shell wall and wherein the protection pipe extends through an opening in the closure plate and is connected to the closure plate.

14. The secondary stave support of claim 1 further comprising a rigid compensator connected to the furnace shell wall and wherein the protection pipe extends through an opening in the rigid compensator and is connected to the rigid compensator.

15. The secondary stave support of claim 1 wherein the water pipe further comprises a fourth portion and wherein the third and fourth portions of the water pipe are integrally cast with the stave.

16. The secondary stave support of claim 1 wherein the third portion of the water pipe is disposed within the stave and connected thereto by a connection selected from the group consisting of soldering, brazing, threading, or welding.

17. The secondary stave support of claim 16 wherein the first gas-tight seal comprises a connection, between an inner surface of the first end of the protection pipe and an outside surface of the third portion of the water pipe, selected from the group consisting of soldering, brazing, threading, or welding.

18. The secondary stave support of claim 17 further comprising a second gas-tight seal between an outer surface of the first end of the protection pipe and an external part of the stave.

19. The secondary stave support of claim 18 further comprising a rigid compensator connected to the furnace shell wall and wherein the second end of the protection pipe extends through an opening in the rigid compensator and is connected to the rigid compensator.

20. The secondary stave support of claim 1 wherein the first gas-tight seal comprises a seal ring connected to the first end of the protection pipe and a third portion of the water pipe.

21. The secondary stave support of claim 20 wherein the first gas-tight seal, comprising the seal ring connected to the first end of the protection pipe and a third portion of the water pipe, is cast into the stave.

22. The secondary stave support of claim 20 wherein the seal ring tapers from a large diameter end to a small diameter end.

23. The secondary stave support of claim 22 wherein at least a portion of the seal ring is cast within the stave.

24. The secondary stave support of claim 22 wherein at least the large diameter end of the seal ring is cast within the stave.

25. The secondary stave support of claim 22 wherein the large diameter end of the seal ring is cast within the stave and the small diameter end of the seal ring protrudes from the stave.

26. The secondary stave support of claim 25 further comprising a second gas-tight seal between an outer surface of the first end of the protection pipe and the small diameter end of the seal ring.

27. The secondary stave support of claim 20 wherein the first gas-tight seal is external to the stave.

28. A method for providing a secondary stave support for a furnace stave with a water pipe having a portion external to the furnace shell wall comprising the steps of:
attaching in a gas-tight manner a first end of a metal protection pipe to an internal co-axial water pipe proximal to the stave;
attaching in a gas-tight manner a second end of the protection pipe to the furnace shell wall such that the second end is not in physical communication with the water pipe portion external to the furnace shell wall.

29. The method for providing a secondary stave support of claim 28 wherein the manner for attaching the first end is selected from welding, brazing, threading or casting.

30. The method for providing a secondary stave support of claim 28 wherein the manner for attaching the second end is selected from welding, brazing, threading or casting.
